(19) United States
(12) Patent Application Publication
(10) Pub. No.: US 2025/0156366 A1
(43) Pub. Date: May 15, 2025

(54) Method and system for optimizing overall throughput of a PCIe/CXL host bridge

(71) Applicant: Intel Corporation, Santa Clara, CA (US)

(72) Inventors: Cong ZHANG, Shanghai (CN); Tao ZHAO, Shanghai (CN); Yi Liu, Shanghai (CN); Jian WANG, Shanghai (CN); Fan WANG, Shanghai (CN); Zhonghua SUN, Shanghai (CN); Xin ZHANG, Shanghai (CN); Di ZHANG, Shanghai (CN)

(21) Appl. No.: 18/657,823

(22) Filed: May 8, 2024

(30) Foreign Application Priority Data
Jan. 30, 2024 (WO) PCT/CN2024/074636

(51) Int. Cl. G06F 13/42; G06F 13/40

(52) U.S. Cl. CPC G06F 13/4282; G06F 13/4022; G06F 2213/0026

(57) ABSTRACT

A method and system for optimizing overall throughput of a Peripheral Component Interconnect Express (PCIe)/Compute Express Link (CXL) host bridge. The PCIe/CXL host bridge includes a plurality of ports, and one or more devices are connected to the ports. Credits are initially allocated to the ports of the PCIe/CXL host bridge. A link status on the ports of the PCIe/CXL host bridge and/or a status of scheduled workloads on a host are then determined. The credits allocated to the ports of the PCIe/CXL host bridge are adjusted based on the link status and/or the status of scheduled workloads. A PCIe driver may detect the link status of each port of the PCIe/CXL host bridge and request to adjust the credits based on the link status. An orchestration software that is configured to schedule and switch workloads may request to adjust the credits based on the status of scheduled workloads.

### BACKGROUND

With the evolution of Peripheral Component Interconnect Express (PCIe) to the latest PCIe Gen7 specification and the new Compute Express Link (CXL), the diversity of input/output (I/O) devices in the platform increases, such as graphics processing units (GPUs), field programmable gate arrays (FPGAs), infrastructure process units (IPUs), CXL memory pool, or the like. All the devices can work in different bandwidths and speeds. Therefore, to optimize the overall throughput of the PCIe/CXL host bridge, it is needed to rebalance the credits resource among these devices according to the bandwidths and speeds of the PCIe/CXL links.

### BRIEF DESCRIPTION OF THE FIGURES

Some examples of apparatuses and/or methods will be described in the following by way of example only, and with reference to the accompanying figures, in which

FIG. 1 shows an example system including a PCIe/CXL host bridge and multiple devices connected to the PCIe/CXL host bridge;

FIG. 2 is a diagram of an example PCIe/CXL system;

FIG. 3 is a flow diagram of an example method for optimizing overall throughput of a PCIe/CXL host bridge;

FIG. 4 is a high-level flow diagram for dynamic credits rebalance for the ports of the PCIe/CXL host bridge in accordance with one example;

FIG. 5A shows a basic input/output system (BIOS) boot flow and a system management interrupt (SMI) handle flow for rebalancing credits in accordance with one example;

FIG. 5B shows an example dynamic credit rebalance (DCR) driver workflow;

FIG. 5C shows an example workflow that the PCIe driver issues a DCR performance profile (DCR-PP) change request;

FIG. 5D shows an example workflow that the orchestration software issues a DCR-PP change request;

FIG. 6 is a block diagram of an electronic apparatus incorporating at least one electronic assembly and/or method described herein;

FIG. 7 illustrates a computing device in accordance with one implementation of the invention; and

FIG. 8 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

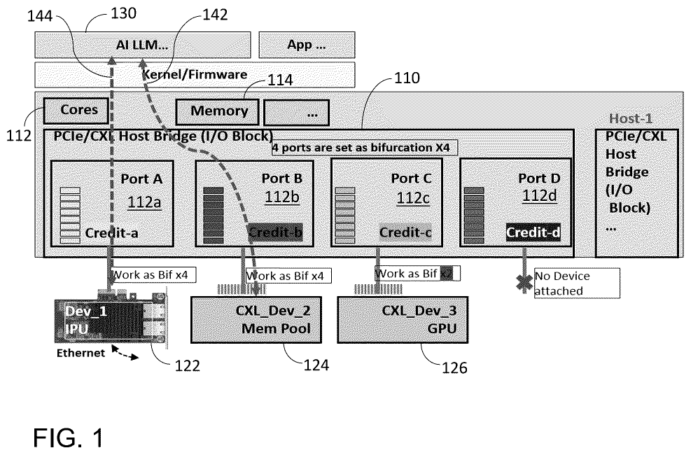

FIG. 1 shows an example system including a PCIe/CXL host bridge 110 and multiple devices 122, 124, 126 connected to the PCIe/CXL host bridge 110. The PCIe/CXL host bridge 110 (I/O block) connects a CPU 112 and a memory subsystem 114 to one or more PCIe or CXL devices 122, 124, 126. The PCIe/CXL host bridge 110 generates transaction requests on behalf of the CPU 112, which is interconnected through a local bus. The PCIe/CXL host bridge 110 includes one or more ports 112a-112d, and one or more PCIe/CXL devices 122, 124, 126 may be connected to the ports on the PCIe/CXL host bridge 110. It should be noted that FIG. 1 shows a PCIe/CXL host bridge 110 including four ports and three devices connected to the PCIe/CXL host bridge 110 as an example, and the PCIe/CXL host bridge 110 may include more or less than four ports and any number of devices can be connected to the PCIe/CXL host bridge 110.

In the example shown in FIG. 1, four (4) ports (ports A-D 112a-112d) of the PCIe/CXL host bridge 110 are set as bifurcation x4. PCIe bifurcation is a feature that allows division of data lanes in a PCIe slot. For example, in a supported system, a PCIe x16 slot can be configured into two PCIe x8 lanes, or more smaller lanes. PCIe bifurcation does not affect overall speed but allows a larger slot to act like multiple smaller slots, allowing the use of advanced expansion cards without additional PCIe bridge chips.

The PCIe protocol operates a credit-based flow control system. A sender is given a certain number of credits for sending data across the PCIe/CXL link and can send data up to the value of those credits. In FIG. 1, credits are allocated to the four ports of the PCIe/CXL host bridge 110 (ports A-D 112a-112d) equally.

In the example shown in FIG. 1, an IPU 122 is connected to port A 112a, a memory device 124 is connected to port B 112b, a GPU 126 is connected to port C 112c, and no device is currently connected to port D 112d, and credits are allocated equally among ports A-D 112a-112d. Since there is no device connected to port D 112d, credits allocated to port D 112d will be wasted. In addition, the memory device 124 connected to port B 112b works as bifurcation x4 while the GPU 126 connected to port C 112c works as bifurcation x2. Therefore, port B 112b needs more credits than port C 112c. This can cause under-utilization of credits totally, reducing the overall throughput of the PCIe/CXL host bridge 110.

Applications may be running on the host. As an example, FIG. 1 shows artificial intelligence (AI) workloads 130 (e.g., transformer models, a large language model (LLM), etc.) running on the host. AI workloads in a training phase mainly need to access data and share parameters. Therefore, during the training phase of the AI workload 130, the dataset transmissions between the host and the memory device 124 will be busy and take more time. The flow of dataset in the training phase of the AI workload 130 is indicated by arrow 142. If port B 112b has a more credit, the dataset will be moved between the host and the memory device 124 with high quality and bandwidth. In the inference phase of the AI workload 130, the AI workloads 130 (e.g., LLM) need dataset input from other machines, and accessing data from the IPU 122 will be busy. The flow of the dataset in the inference phase of the AI workload 130 is indicated by arow 144. Therefore, during the inference phase, port A 112a should support major data loading based on the credit allocated to port A 112a.

The problem in the conventional PCIe flow control mechanism is that credits are pre-allocated according to the bifurcation setting before link training and it does not consider the link status or speed. High-speed devices will not be allocated more credits than low-speed devices. Even though no device is connected to a port, the port will also be allocated with credits. This results in insufficient credits for high-speed devices and redundant credits for low-speed devices, which in turn leads to the reduced overall throughput of the PCIe/CXL host bridge.

In the conventional scheme, basic input/output system (BIOS) pre-allocates credits statically according to the PCIe/CXL host bridge bifurcation setting before link training. Once credit is initialized, no further adjustments will be made unless the bifurcation configuration is changed via BIOS knobs and rebooted to allow the BIOS to reinitialize it. The hardware feature of shared credit pool was introduced in PCIe Gen6 specification. However, it is for sharing credits between different virtual channels in the same link and does not apply to the credit adjustment of the whole host bridge (multiple independent links).

Hereafter, example schemes are disclosed to optimize/improve the overall throughput of the PCIe/CXL host bridge. In examples, the credits resource is rebalanced/adjusted across the PCIe/CXL root ports within a PCIe/CXL host bridge according to a link status on the ports of the PCIe/CXL host bridge and/or a status of scheduled workloads.

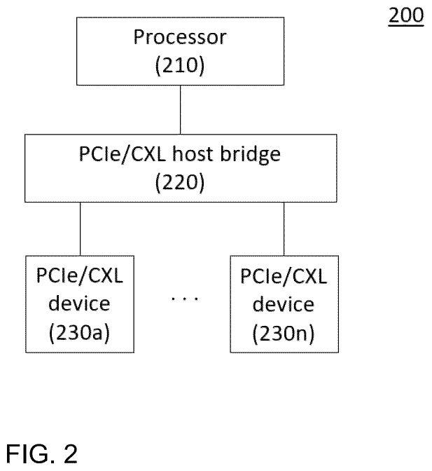

FIG. 2 is a diagram of an example PCIe/CXL system 200. The system 200 includes a processor 210 and a PCIe/CXL host bridge 220. The PCIe/CXL host bridge 220 includes a plurality of ports for connecting to one or more PCIe/CXL devices 230a-230n. The processor 210 (software modules running on the processor 210) is configured to allocate credits to the ports of the PCIe/CXL host bridge 220, determine a link status on the ports of the PCIe/CXL host bridge 220 and/or a status of scheduled workloads on a host, and adjust the credits allocated to the ports of the PCIe/CXL host bridge 220 based on the link status and/or the status of scheduled workloads.

In examples, the BIOS may initially allocate the credits to the ports of the PCIe/CXL host bridge 220 according to bifurcation setting for the ports of the PCIe/CXL host bridge 220. The BIOS may be configured to report the allocation of the credits to a dynamic credit rebalance (DCR) module (e.g., a DCR driver). Hereafter, the terms DCR module and DCR driver will be used interchangeably. The DCR module is a software tool that is configured to dynamically rebalance the credits allocated to the ports of the PCIe/CXL host bridge. The DCR module may be configured to generate a dynamic credit rebalance performance profile (DCR-PP) based on the allocation of the credits reported by the BIOS. The DCR-PP is a data structure that includes the credits currently allocated to the ports of the PCIe/CXL host bridge 220. The BIOS may be configured to report the allocation of the credits to the DCR module using an Advanced Configuration and Power Interface (ACPI) function in _DSM method.

ACPI is an open standard that operating systems (OS) can use to discover and configure computer hardware components, to perform power management, auto configuration, and status monitoring. The ACPI specification is central to the Operating System-directed configuration and Power Management (OSPM) system. Once an OSPM-compatible operating system activates ACPI, it takes control of all aspects of power management and device configuration. OSPM is a computer specification for device configuration and power management by the operating system. The _DSM (device specific method) is a control method that enables devices to provide device specific control functions that are consumed by the device driver.

The DCR module may be configured to receive a DCR-PP change request from a PCIe driver (e.g., a software module in OSPM) or an orchestration software. The DCR module then triggers an SMI in response to receiving the DCR-PP change request. The BIOS is configured to adjust the credits in the system management mode (SMM).

In some examples, a PCIe driver may be configured to detect the link status of each port of the PCIe/CXL host bridge 220 and determine whether to issue the DCR-PP change request to the DCR module based on the link status. In some examples, an orchestration software that is configured to schedule and switch workloads may be configured to determine whether to issue the DCR-PP change request to the DCR module based on the status of scheduled workloads. As an example, the workloads may be AI workloads, and the credits may be allocated differently in a training phase and an inference phase of the AI workloads.

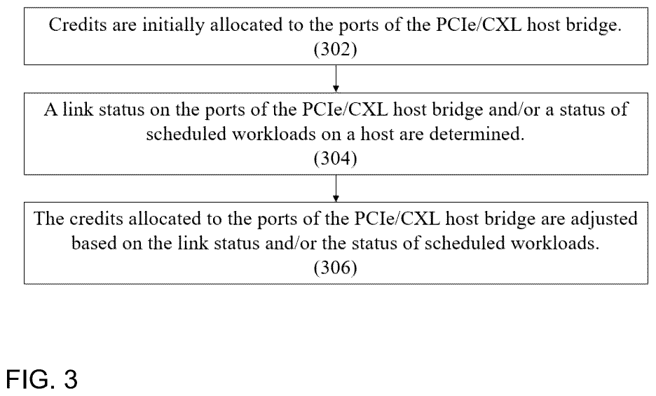

FIG. 3 is a flow diagram of an example method for optimizing overall throughput of a PCIe/CXL host bridge 220. The PCIe/CXL host bridge 220 includes a plurality of ports, and one or more devices 230a-230n are connected to the ports. Credits are initially allocated to the ports of the PCIe/CXL host bridge 220 (302). In examples, the BIOS may initially allocate the credits to the ports of the PCIe/CXL host bridge 220 according to bifurcation setting for the ports of the PCIe/CXL host bridge 220. The BIOS may then report the allocation of the credits to a DCR driver. The DCR driver is a software tool that is configured to dynamically rebalance the credits allocated to the ports of the PCIe/CXL host bridge. The BIOS may report the allocation of the credits to the DCR driver using an ACPI function in _DSM method. The DCR driver may then generate, and maintain, a DCR-PP based on the allocation of the credits reported by the BIOS. The DCR-PP includes credits allocated to the ports of the PCIe/CXL host bridge 220.

A link status on the ports of the PCIe/CXL host bridge 220 and/or a status of scheduled workloads on a host are determined (304). For example, a PCIe driver may monitor and detect a link status (e.g., link failure, link downgrade, power loss, etc.) on the ports of the PCIe/CXL host bridge 220. An orchestration software (workload scheduler) that is configured to schedule and switch workloads may monitor and detect a status of scheduled workloads on a host. The PCIe driver and the orchestration software may then determine whether to issue a DCR-PP change request (i.e., whether to rebalance the credits allocated to the ports of the PCIe/CXL host bridge 220) based on the link status and the status of scheduled workloads, respectively.

The credits allocated to the ports of the PCIe/CXL host bridge are then adjusted based on the link status and/or the status of scheduled workloads (206). In examples, the PCIe driver and the orchestration software may obtain the current credits allocation from the DCR driver. For example, the PCIe driver and the orchestration software may send a DCR-PP configuration discovery request to the DCR driver and the DCR driver may provide a current DCR-PP to the PCIe driver and the orchestration software, respectively. The PCIe driver and the orchestration software may then determine whether to issue a DCR-PP change request (i.e., whether to request for adjusting the credits allocation) to the DCR driver based on the link status and the status of scheduled workloads, respectively.

The DCR driver receives a DCR-PP change request from the PCIe driver or the orchestration software and then triggers an SMI in response to receiving the DCR-PP change request. The credits are then reallocated by the BIOS based on the request. The BIOS may notify the re-allocation of the credits to the DCR driver. The DCR driver may then update the DCR-PP.

In examples, credits allocated to the ports of the PCIe/CXL host bridge 220 may be rebalanced dynamically based on the real-time link status (e.g., link failure, link downgrade, power loss, etc.) and/or the status of scheduled workloads (i.e., workload changes). In examples, credits may be allocated to the ports of the PCIe/CXL host bridge 220 differently depending on the phase of workloads. For example, the workloads may be AI workloads, and the credits may be allocated differently in a training phase and in an inference phase of the AI workloads.

Example mechanisms for dynamic credits rebalance (DCR) for the ports of a PCIe/CXL host bridge 220 to improve throughput of the host bridge 220 will be explained in detail hereafter.

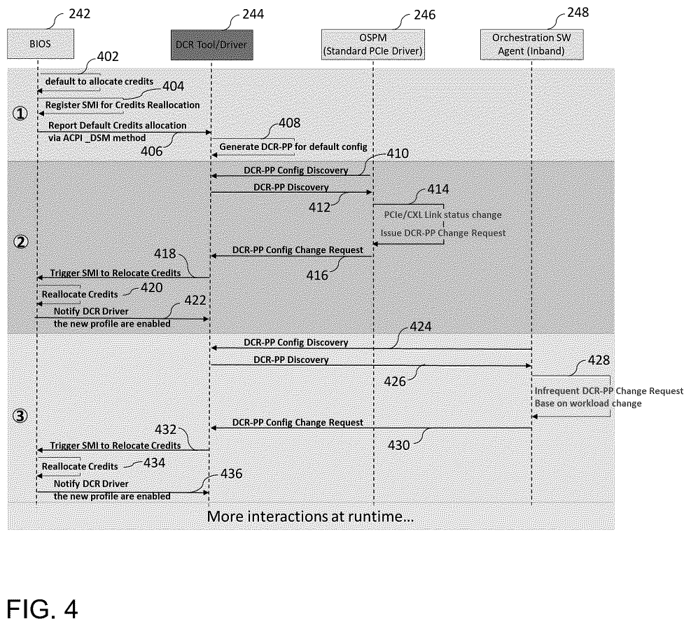

FIG. 4 is a high-level flow diagram for dynamic credits rebalance for the ports of the PCIe/CXL host bridge 220 in accordance with one example. The dynamic credits rebalancing for the ports of the host bridge 220 may be implemented by software modules, for example a BIOS 242, a DCR module (driver) 244, a PCIe driver 246 (e.g., a software module in OSPM), and an orchestration software 248. The first phase is an initialization phase for initially allocating credits to the ports of the host bridge 220 and the next phase is a rebalancing phase for dynamically adjusting the allocated credits based on a link status and/or a status of scheduled workloads.

The BIOS 242 initially allocates credits to the ports of the host bridge 220 (402). For example, the BIOS 242 may allocate credits to the ports of the host bridge 220 based on the bifurcation setting for the ports of the host bridge 220. The BIOS 242 then registers a system management interrupt (SMI) to rebalance/adjust the credits at runtime (404). An SMI is an interrupt that gets generated so the processor can service server management events. An SMI handler (the code that executes in a system management mode (SMM)) is instantiated from the BIOS. The BIOS 242 then reports the allocation of the (default) credits to a DCR driver 244 (406). In examples, the BIOS 242 may report the allocation of the credits via ACPI function in _DSM method.

The DCR driver 244 then generates, and maintains, a DCR-PP based on the allocation of credits reported by the BIOS 242 (408). The DCR-PP is a data structure including current credits allocation to the ports of the host bridge 220. The DCR driver 244 maintains the DCR-PP and triggers the SMI according to a DCR-PP change request. The DCR-PP change request may be received from the PCIe driver 246 or the orchestration software 248.

The PCIe driver 246 may send a DCR-PP discovery request to the DCR driver 244 to retrieve the current credits allocation to the ports of the host bridge 220 (410). In response, the DCR driver 244 provides the DCR-PP to the PCIe driver 246 (412). The PCIe driver 246 monitors the link status on the ports of the host bridge 220. When a link status change is detected, the PCIe driver 246 determines whether to request for change of the credits on the ports of the host bridge 220 (414). If the PCIe driver 246 determines to request for change of the credits allocation, the PCIe driver 246 sends a DCR-PP change request to the DCR driver 244 (416). The PCIe driver 246 may initiate the DCR-PP change request based on the current link status and link status change. Upon receipt of the DCR-PP change request, the DCR driver 244 triggers an SMI to reallocate the credits (418). The BIOS 242 then reallocates the credits based on the request (420). The BIOS 242 notifies the DCR driver 244 that the new DCR-PP is enabled (422).

Both the PCIe driver and the orchestration software can determine the need to update the credits allocation under certain circumstances. For a PCIe driver, there are two example scenarios that the PCIe driver triggers Dynamic Credits Rebalance (DCR). One example is when the system is just booted up and the PCIe driver is loaded, the PCIe driver will scan all the link status of the current I/O block (PCIe host bridge), including a link width, a link speed, etc. and then decide whether credits reallocation is needed. For example, if some ports link training fails (triggered by the BIOS), then the PCIe driver detects this situation and determines whether to issue a DCR-PP change request to the DCR driver to reallocate credits from that failed port to the available port(s).

Another example is that when an OS is running, and a fatal link error occurs which causes a link down, the PCIe driver can also detect this status change and issue a DCR-PP change request to the DCR driver to reallocate the credits of the failed port to the available port.

For an orchestration software, the orchestrator may trigger the DCR to reallocate credits according to the change of workload. It is more typical that in the LLM use case, the resources required for training and inference phases are different, and the bandwidth requirements for a NIC/graphics processor(s)/SSD are also different, which leads to the need to adjust the allocation of credits in different phases, in order to optimize the throughputs of the whole I/O block, and to ensure the optimal performance.

The BIOS registers an SMI handler in the boot phase, and the DCR driver may trigger this SMI handler at runtime phase according to the DCR-PP change request, which is the input from the PCIe driver and the orchestration software. After credit rebalancing, credit rebalancing success with the new request is notified to the DCR driver before updating the DCR-PP.

The orchestration software 248 (workload scheduler) may initiate a DCR-PP change request (i.e., rebalancing the credits allocated to the ports of the host bridge 220) based on the status of scheduled workloads to improve the I/O block (PCIe/CXL host bridge) throughput. The orchestration software 248 is responsible for scheduling workloads and workload management and monitoring. The orchestration software 248 can get the current DCR-PP (i.e., the current credits allocation) for the PCIe/CXL host bridge 220 from the DCR driver 244, and then decide whether to issue a DCR-PP change request (i.e., whether to request for change of the credits allocation) based on the status of scheduled workloads.

The orchestration software 248 may send a DCR-PP discovery request to the DCR driver 244 to retrieve the current credits allocation (424). In response, the DCR driver 244 provides the DCR-PP to the orchestration software 248 (426). The orchestration software 248 then determines whether to request for change of the credits on the ports of the host bridge 220 based on the workloads change (428). If the orchestration software 248 determines to request for change of the credits allocation, the orchestration software 248 sends a DCR-PP change request to the DCR driver 244 (430). Upon receipt of the DCR-PP change request, the DCR driver 244 triggers an SMI to reallocate the credits (432). The BIOS 242 then reallocates the credits based on the request (434). The BIOS 242 notifies the DCR driver 244 that the new DCR-PP is enabled (436).

In examples, the PCIe driver (i.e., OSPM) may change the credit allocation based on the link status (e.g., link speed, link bandwidth, link up/down, or the like) to optimize the I/O block throughput. For example, up to 8 times credits increase may be achieved to increase throughput in case of x2x2x2x2x2x2x2x2 bifurcation when only one x2 link is up. The orchestration software agent can also change the credits allocation based on the system workloads to improve the I/O block throughput.

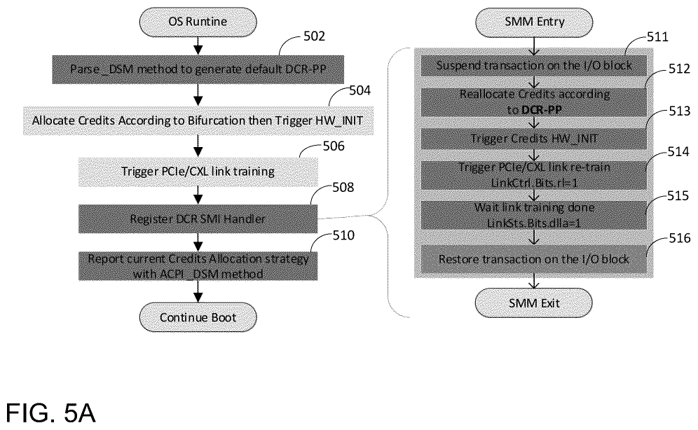

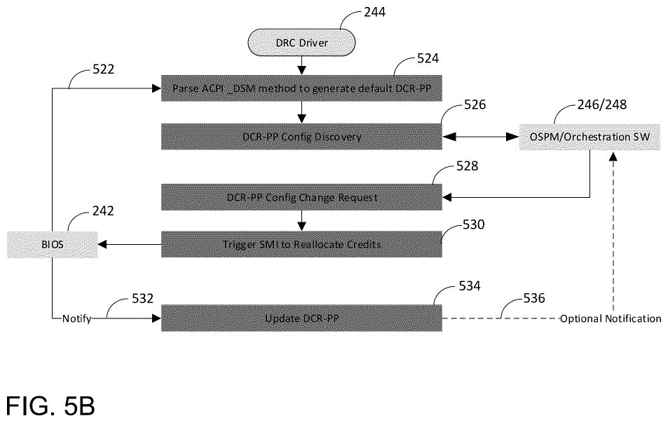

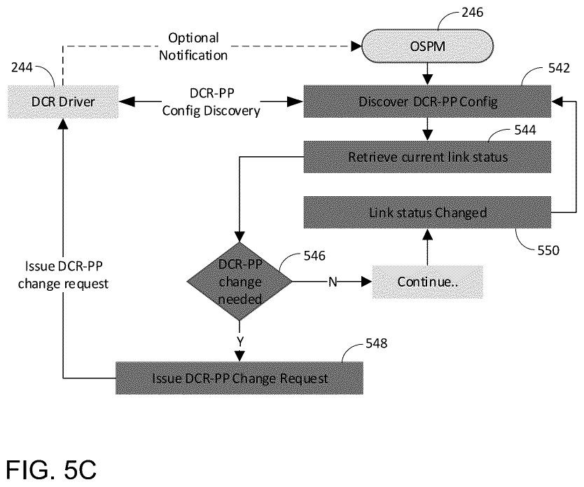

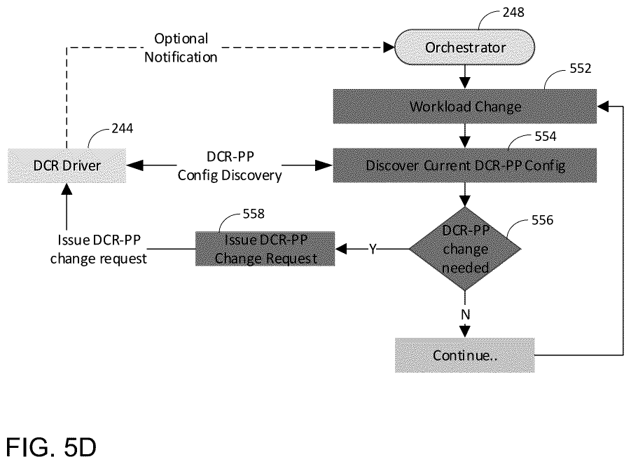

FIG. 5A shows a BIOS boot flow and an SMI handle flow for rebalancing credits in accordance with one example. Initially the credits are allocated based on the default credits allocation strategy. The BIOS generates _DSM method to report the default credit allocation and the _DSM method is parsed by the DCR driver to generate the DCR-PP (502). BIOS reports the ACPI _DSM method to the OS, and _DSM is a static method that can be parsed by various OS drivers. In examples, the _DSM method for DCR will be parsed by the DCR driver, which generates the DCR-PP. ACPI is a regular means for the BIOS to report hardware information to the OS. The BIOS reports the default credit allocation to the OS for the DCR driver to maintain a default config of DCR-PP.

The BIOS allocates credits in the PCIe/CXL host bridge 220 according to the PCIe/CXL bifurcation setting and triggers HW_INIT (504). PCIe/CXL link training is then triggered (506). The BIOS registers an SMI handler to implement dynamic credit rebalance in an SMM mode (508). The BIOS reports the current credits allocation to the DCR driver, e.g., using an ACPI function in _DSM method (510).

The system may enter an SMM if the SMI is triggered. In the SMM, the BIOS suspends transactions on the PCIe/CXL host bridge 20 (I/O block) (511) and reallocates credits to the ports of the PCIe/CXL host bridge 220 based on the DCR-PP (512). The BIOS then triggers HW_INIT (513). PCIe/CXL link (re)training is then triggered (514). Once the PCIe/CXL link training is done (515), transaction on the I/O block (the host bridge 220) is restored (516). Before rebalancing credits, the BIOS needs to ensure that there are no outstanding transactions for the device by clear Bus Master Enable and SERR #Enable bits and set Interrupt Disable bit in the Command register. After credits are rebalanced, the BIOS will restore the above bits in the Command register.

In examples, a new _DSM function in PC e root device (HI D=“PNP0A08”) and CXL root device (HTD=“ACPI0017”) may be used to report the credits allocation strategy to the DCR driver. The _DSM is a control method that enables devices to provide device specific control functions that are consumed by the device driver. The _DSM method includes an argument (Arg0) for a buffer containing a Universally Unique Identifier (UUID), an argument (Arg1) for an integer containing the revision ID which is the function's revision and specific to the UUID, an argument (Arg2) for an integer containing the function index that represents a specific function whose meaning is specific to the UUID and the revision ID, and an argument (Arg3) for a package that contains function-specific arguments (a package containing the parameters for the function specified by the UUID, revision ID and function index).

Table 1 shows an example _DSM for retrieving credits allocation.

TABLE 1
Location:
This object shall be a child of the PCIe Root Device (HID=
“PNP0A08”) and CXL Root Device (HID= “ACPI0017”).
Arguments:

| | |
|---|---|
| Arg0: | A Buffer containing a UUID |
| Arg1: | An Integer containing the Revision ID |
| Arg2: | An Integer containing the Function Index |
| Arg3: | A package of IO Block Credits Allocation characteristic. |
| | The package containing one WORD in the first reversion. |
| | Package { |
| | WORD Credits Scaled |
| | } |

```
Return:
A package containing several packages, each sub-package containing 2
elements - a WORD that returns the _UID of associated root port, and
a package containing the Credits numbers allocated to the root port.
Package {
  Package {
      WORD _UID
      Package {
        WORD PH Credits
        WORD PD Credits
        WORD NPH Credits
        WORD NPL Credits
        WORD CPLH Credits
        WORD CPLD Credits
      }
  }
}
```

The DCR driver triggers the software SMI to allow the BIOS to rebalance credits in an SMM. The DCR driver initially generates the default DCR-PP based on the _DSM method reported by the BIOS. The DCR driver may provide a current DCR-PP to the PCIe driver and the orchestration software when requested from the PCIe driver and the orchestration software. The DCR driver stores the DCR-PP change request received from the PCIe driver and the orchestration software and triggers an SMI to rebalance the credits.

FIG. 5B shows an example DCR driver workflow. The DCR driver 244 receives the credits allocation from the BIOS 242, e.g., with the ACPI _DSM method (522). The DCR driver 244 parses the ACPI _DSM method and generates a default DCR-PP (524). If the DCR driver 244 receives a DCR-PP configuration discovery request from the PCIe driver (OSPM) 246 or the orchestration software 248, the DCR driver 244 provides the current DCR-PP to the PCIe driver (OSPM) 246 and the orchestration software 248, respectively (526).

If the DCR driver 244 receives a DCR-PP configuration change request from the PCIe driver (OSPM) 246 or the orchestration software 248 (528), the DCR driver 244 triggers an SMI to reallocate credits to the ports of the host bridge 220 (530). The BIOS 242 then reallocates the credits and notifies it to the DCR driver 244 (532). The DCR driver 244 then updates the DCR-PP (534) and may optionally notify the PCIe driver (OSPM) 246 or the orchestration software 248 of the DCR-PP configuration change (536).

FIG. 5C shows an example workflow that the PCIe driver (OSPM) 246 issues a DCR-PP change request. The PCIe driver (OSPM) 246 discovers the DCR-PP from the DCR driver 244 (542). The PCIe driver (OSPM) 246 sends a DCR-PP configuration discovery request to the DCR driver 244 and, in response, receives DCR-PP from the DCR driver 244. The PCIe driver (OSPM) 246 monitors a current link status on the ports of the host bridge 220 (544). The PCIe driver (OSPM) 246 monitors and detects the link status of each port in PCIe/CXL host bridge 220. For example, the PCIe driver (OSPM) 246 may detect link down, link bandwidth degradation, etc. For example, the link power loss will trigger an ACPI event to notify the PCIe driver in the OSPM of the link status change. Similarly, a link error will have the RAS flow notify the drivers. The PCIe driver (OSPM) 246 then decides whether to issue a DCR-PP change request according to the latest link status.

The PCIe driver (OSPM) 246 decides whether DCR-PP change is needed, i.e., whether to issue a DCR-PP change request, based on the detected link status (546). If it is determined that DCR-PP change is needed, the PCIe driver (OSPM) 246 issues a DCR-PP change request to the DCR driver 244 (548). After issuing the DCR-PP change request, the PCIe driver (OSPM) waits for the BIOS to complete the credits rebalance. The DCR driver 244 may optionally notify the PCIe driver (OSPM) 246 of the DCR-PP update. If it is determined that DCR-PP change is not needed based on the current link status, the process continues to monitor the link status and if the link status changes (550), the process returns to step 542 for retrieving the current DCR-PP configuration.

FIG. 5D shows an example workflow that the orchestration software 248 issues a DCR-PP change request. The orchestration software 248 detects workload change (552). The orchestration software 248 is responsible for scheduling and switching workloads and may detect the status of scheduled workload and the workload changes.

The orchestration software 248 may retrieve the current DCR-PP configuration from the DCR driver 244 (554). The orchestration software 248 may obtain the current DCR-PP configuration for the PCIe/CXL host bridge 220 from the DCR driver 244, and then decide whether to issue a DCR-PP change request based on its scheduled workload.

The orchestration software 248 determines whether a DCR-PP change is needed (556). The orchestration software 248 determines whether the current DCR-PP is optimal under the current workloads. If it is determined that the current DCR-PP is not optimal, the orchestration software 248 issues a DCR-PP change request to the DCR driver 244 to rebalance credits (558). If it is determined that a DCR-PP change is not needed, the process continues, and the orchestration software 248 continues monitoring the workloads. The DCR driver 244 then updates the DCR-PP and may optionally notify the orchestration software 248 of the DCR-PP configuration change.

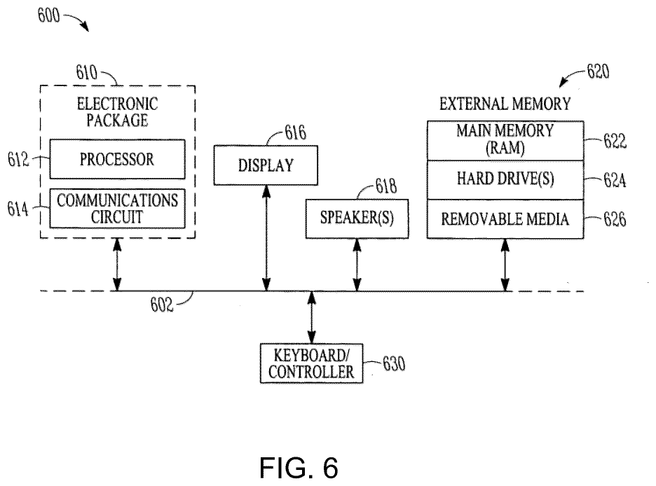

FIG. 6 is a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASlC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

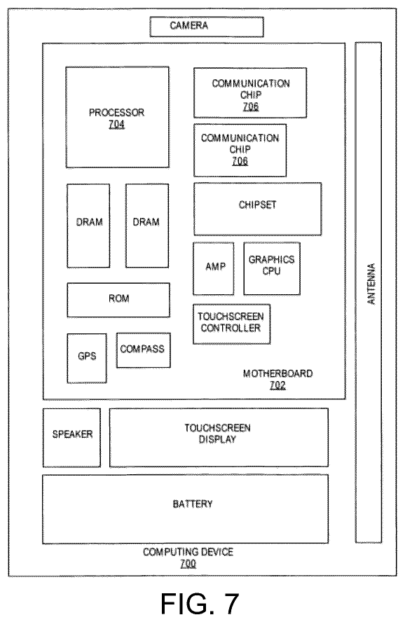

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

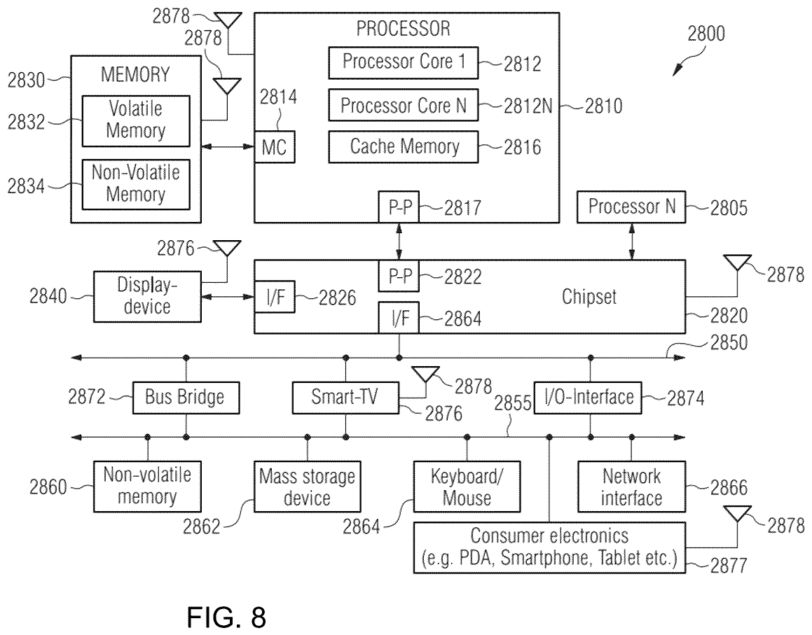

FIG. 8 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for optimizing overall throughput of a PCIe/CXL host bridge. The PCIe/CXL host bridge includes a plurality of ports, and one or more devices are connected to the ports. The method includes allocating credits to the ports of the PCIe/CXL host bridge, determining a link status on the ports of the PCIe/CXL host bridge and/or a status of scheduled workloads on a host, and adjusting the credits allocated to the ports of the PCIe/CXL host bridge based on the link status and/or the status of scheduled workloads.

Another example, (e.g., example 2) relates to a previously described example (e.g., example 1), wherein BIOS initially allocates the credits to the ports of the PCIe/CXL host bridge according to bifurcation setting for the ports of the PCIe/CXL host bridge.

Another example, (e.g., example 3) relates to a previously described example (e.g., example 2), further including the BIOS reporting the allocation of the credits to a DCR module, and the DCR module generating a DCR-PP based on the allocation of the credits reported by the BIOS.

Another example, (e.g., example 4) relates to a previously described example (e.g., example 3), further comprising the DCR module receiving a DCR-PP change request, the DCR module triggering a SMI in response to receiving the DCR-PP change request, and the BIOS adjusting the credits in a system management mode.

Another example, (e.g., example 5) relates to a previously described example (e.g., example 4), wherein a PCIe driver detects the link status of each port of the PCIe/CXL host bridge and determines whether to issue the DCR-PP change request to the DCR module based on the link status.

Another example, (e.g., example 6) relates to a previously described example (e.g., any one of examples 4-5), wherein an orchestration software that is configured to schedule and switch workloads determines whether to issue the DCR-PP change request to the DCR module based on the status of scheduled workloads.

Another example, (e.g., example 7) relates to a previously described example (e.g., any one of examples 3-6), wherein the BIOS reports the allocation of the credits to the DCR module using an ACPI function in _DSM method.

Another example, (e.g., example 8) relates to a previously described example (e.g., any one of examples 1-7), wherein the workloads are AI workloads.

Another example, (e.g., example 9) relates to a previously described example (e.g., example 8), wherein the credits are allocated differently in a training phase and an inference phase of the AI workloads.

Another example, (e.g., example 10) relates to a system comprising a processor, and a PCIe/CXL host bridge including a plurality of ports for connecting to one or more devices. The processor is configured to allocate credits to the ports of the PCIe/CXL host bridge, determine a link status on the ports of the PCIe/CXL host bridge and/or a status of scheduled workloads on a host, and adjust the credits allocated to the ports of the PCIe/CXL host bridge based on the link status and/or the status of scheduled workloads.

Another example, (e.g., example 11) relates to a previously described example (e.g., example 10), wherein BIOS initially allocates the credits to the ports of the PCIe/CXL host bridge according to bifurcation setting for the ports of the PCIe/CXL host bridge.

Another example, (e.g., example 12) relates to a previously described example (e.g., example 11), wherein the BIOS is configured to report the allocation of the credits to a DCR module, and the DCR module is configured to generate a DCR-PP based on the allocation of the credits reported by the BIOS.

Another example, (e.g., example 13) relates to a previously described example (e.g., example 12), wherein the DCR module is configured to receive a DCR-PP change request and trigger a SMI in response to receiving the DCR-PP change request, and the BIOS is configured to adjust the credits in a system management mode.

Another example, (e.g., example 14) relates to a previously described example (e.g., example 13), wherein a PCIe driver is configured to detect the link status of each port of the PCIe/CXL host bridge and determine whether to issue the DCR-PP change request to the DCR module based on the link status.

Another example, (e.g., example 15) relates to a previously described example (e.g., any one of examples 13-14), wherein an orchestration software that is configured to schedule and switch workloads is configured to determine whether to issue the DCR-PP change request to the DCR module based on the status of scheduled workloads.

Another example, (e.g., example 16) relates to a previously described example (e.g., any one of examples 12-15), wherein the BIOS is configured to report the allocation of the credits to the DCR module using an ACPI function in _DSM method.

Another example, (e.g., example 17) relates to a previously described example (e.g., any one of examples 10-16), wherein the workloads are AI workloads.

Another example, (e.g., example 18) relates to a previously described example (e.g., example 17), wherein the credits are allocated differently in a training phase and an inference phase of the AI workloads.

Another example, (e.g., example 19) relates to a machine-readable medium including code, when executed, to cause a machine to perform the method as in any one of examples 1-9.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for optimizing overall throughput of a Peripheral Component Interconnect Express (PCIe)/Compute Express Link (CXL) host bridge, wherein the PCIe/CXL host bridge includes a plurality of ports, and one or more devices are connected to the ports, the method comprising:
allocating credits to the ports of the PCIe/CXL host bridge;
determining a link status on the ports of the PCIe/CXL host bridge and/or a status of scheduled workloads on a host; and
adjusting the credits allocated to the ports of the PCIe/CXL host bridge based on the link status and/or the status of scheduled workloads.

2. The method of claim 1, wherein basic input/output system (BIOS) initially allocates the credits to the ports of the PCIe/CXL host bridge according to bifurcation setting for the ports of the PCIe/CXL host bridge.

3. The method of claim 2, further comprising:
the BIOS reporting the allocation of the credits to a dynamic credit rebalance (DCR) module; and
the DCR module generating a dynamic credit rebalance-performance profile (DCR-PP) based on the allocation of the credits reported by the BIOS.

4. The method of claim 3, further comprising:
the DCR module receiving a DCR-PP change request;
the DCR module triggering a system management interrupt (SMI) in response to receiving the DCR-PP change request; and
the BIOS adjusting the credits in a system management mode.

5. The method of claim 4, wherein a PCIe driver detects the link status of each port of the PCIe/CXL host bridge and determines whether to issue the DCR-PP change request to the DCR module based on the link status.

6. The method of claim 4, wherein an orchestration software that is configured to schedule and switch workloads determines whether to issue the DCR-PP change request to the DCR module based on the status of scheduled workloads.

7. The method of claim 3, wherein the BIOS reports the allocation of the credits to the DCR module using an ACPI function in _DSM method.

8. The method of claim 1, wherein the workloads are artificial intelligence (AI) workloads.

9. The method of claim 8, wherein the credits are allocated differently in a training phase and an inference phase of the AI workloads.

10. A system comprising:
a processor; and
a Peripheral Component Interconnect Express (PCIe)/Compute Express Link (CXL) host bridge including a plurality of ports for connecting to one or more devices,
wherein the processor is configured to allocate credits to the ports of the PCIe/CXL host bridge, determine a link status on the ports of the PCIe/CXL host bridge and/or a status of scheduled workloads on a host, and adjust the credits allocated to the ports of the PCIe/CXL host bridge based on the link status and/or the status of scheduled workloads.

11. The system of claim 10, wherein basic input/output system (BIOS) initially allocates the credits to the ports of the PCIe/CXL host bridge according to bifurcation setting for the ports of the PCIe/CXL host bridge.

12. The system of claim 11, wherein the BIOS is configured to report the allocation of the credits to a dynamic credit rebalance (DCR) module, and the DCR module is configured to generate a dynamic credit rebalance-performance profile (DCR-PP) based on the allocation of the credits reported by the BIOS.

13. The system of claim 12, wherein the DCR module is configured to receive a DCR-PP change request and trigger a system management interrupt (SMI) in response to receiving the DCR-PP change request, and the BIOS is configured to adjust the credits in a system management mode.

14. The system of claim 13, wherein a PCIe driver is configured to detect the link status of each port of the PCIe/CXL host bridge and determine whether to issue the DCR-PP change request to the DCR module based on the link status.

15. The system of claim 13, wherein an orchestration software that is configured to schedule and switch workloads is configured to determine whether to issue the DCR-PP change request to the DCR module based on the status of scheduled workloads.

16. The system of claim 12, wherein the BIOS is configured to report the allocation of the credits to the DCR module using an ACPI function in _DSM method.

17. The system of claim 10, wherein the workloads are artificial intelligence (AI) workloads.

18. The system of claim 17, wherein the credits are allocated differently in a training phase and an inference phase of the AI workloads.

19. A machine-readable medium including code, when executed, to cause a machine to perform the method of claim 1.
